(19) United States
(12) Patent Application Publication
(10) Pub. No.: US 2019/0084141 A1
(43) Pub. Date: Mar. 21, 2019

(54) MULTIFUNCTIONAL TOOL

(71) Applicant: Intercast & Forge Pty Limited, Wingfield (AU)

(72) Inventors: Brenton Keast, Wingfield (AU); Matthew Rawlison, Wingfield (AU); Steven Harkness, Wingfield (AU)

(73) Assignee: Intercast & Forge Pty Limited, Wingfield (AU)

(21) Appl. No.: 16/137,441

(22) Filed: Sep. 20, 2018

(30) Foreign Application Priority Data
Sep. 21, 2017 (AU) 2017903834

(51) Int. Cl. B25F 1/00; B25B 13/08; B25D 1/04; B67B 7/16

(52) U.S. Cl. CPC B25F 1/006; B67B 7/16; B25D 1/04; B25B 13/08

(57) ABSTRACT

A multifunction (multi) tool, such as a tool used for camping, is provided. In one aspect, the multi tool includes a single, unitary body having a hammer with a head, a face, and a handle. In a further aspect, the multi tool additionally includes one or more of: a spike; a U-shaped wrench opening; an elongate slot for engaging a pin of a D-shackle; an aperture for engaging a nut fastener; and a bottle opener. Such a multi tool replaces multiple tools, including a hammer, a crowbar, a wrench, and a bottle opener, with a single tool.

### BACKGROUND

Camping is an outdoor activity involving overnight stays away from home in a shelter such as a tent, a caravan, or a motorhome. Practically all types of camping require at least some equipment, but the preference is generally to keep the amount of equipment taken on a camping trip to a minimum, for reasons of simplicity, expeditiousness, and weight savings.

It is against this background and the problems and difficulties associated therewith that the embodiments of the present disclosure have been developed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

According to a first aspect, there is provided a multi tool comprising a single, unitary body, the body comprising a hammer comprising a head, a face, and a handle and further comprising one or more of:

a spike;

a U-shaped wrench opening;

an elongate slot for engaging a pin of a D-shackle;

at least one aperture for engaging a nut; and

a bottle opener.

In one form, the head comprises the spike.

In one form, the head comprises the U-shaped wrench opening.

According to a further aspect, there is provided a multi tool comprising a single, unitary body, the body comprising a hammer comprising a head, a face, and a handle, and further comprising a spike extending rearward relative to the face of the hammer, and a U-shaped wrench opening rearward relative to the face of the hammer.

In one form, the handle comprises the bottle opener.

In one form, the handle comprises the long slot.

In one form, the handle comprises the stepped slot.

In one form, the spike extends rearward relative to the face of the hammer.

In one form, the U-shaped wrench opening opens rearward relative to the face of the hammer.

In one form, the elongate slot extends along the handle.

In one form, the body comprises a plurality of apertures for engaging nut fasteners, where each aperture is sized to engage a different sized nut.

In one form, the plurality of apertures for engaging nut fasteners is spaced apart along the handle.

In one form, in an alternative the aperture for engaging a nut fastener comprises a stepped slot for engaging various nut sizes.

In one form, the stepped slot extends along the handle.

In one form, the bottle opener is at the end of the handle.

In one form, the single, unitary body is made from a metal.

In one form, the metal is heat treated.

In one form, the single, unitary body is formed primarily by a casting process.

In one form, the body is manufactured using a machining process.

In one form, in an alternative, the single, unitary body is formed by a 3D printing process.

In one form, the body comprises each of the spike, the U-shaped wrench opening, the elongate slot for engaging a pin of a D-shackle, the stepped slot for engaging various nut sizes, and the bottle opener.

According to a further aspect, there is provided a hammer comprising a unitary body, the body comprising a head comprising a face, and a handle, and further comprising one or more of:

a spike;

a U-shaped wrench opening;

an elongate slot for engaging a pin of a D-shackle;

at least one aperture for engaging a nut fastener; and

a bottle opener.

### DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIG. 1 is a front right top perspective view illustrating one representative embodiment of a multifunction (multi) tool, in accordance with an aspect of the present disclosure;

FIG. 2 is a front right bottom perspective view of the multi tool of FIG. 1;

FIG. 3 is a right side view of the multi tool of FIG. 1;

FIG. 4 is a left side view of the multi tool of FIG. 1;

FIG. 5 is a bottom view of the multi tool of FIG. 1;

FIG. 6 is a top view of the multi tool of FIG. 1;

FIG. 7 is front view of the multi tool of FIG. 1; and

FIG. 8 is a rear view of the multi tool of FIG. 1.

### DETAILED DESCRIPTION

The detailed description set forth below in connection with the appended drawings, where like numerals reference like elements, are intended as a description of various embodiments of the present disclosure and are not intended to represent the only embodiments. Each embodiment described in this disclosure is provided merely as an example or illustration and should not be construed as precluding other embodiments. The illustrative examples provided herein are not intended to be exhaustive or to limit the disclosure to the precise forms disclosed.

In the following description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

For ease of description, an automatic door bottom seal assembly is described below in its usual assembled position as shown in the accompanying drawings, and terms such as front, rear, upper, lower, horizontal, longitudinal etc., may be used with reference to this usual position. However, the automatic door bottom seal assembly may be manufactured, transported, sold, or used in orientations other than that described and shown here. These references, and other similar references in the present application, are only to assist in helping describe and to understand the particular embodiment and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, lists of two or more elements of the form, for example, “at least one of A, B, and C,” is intended to mean (A), (B), (C), (A and B), (A and C), (B and C), or (A, B, and C), and further includes all similar permutations when any other quantity of elements is listed.

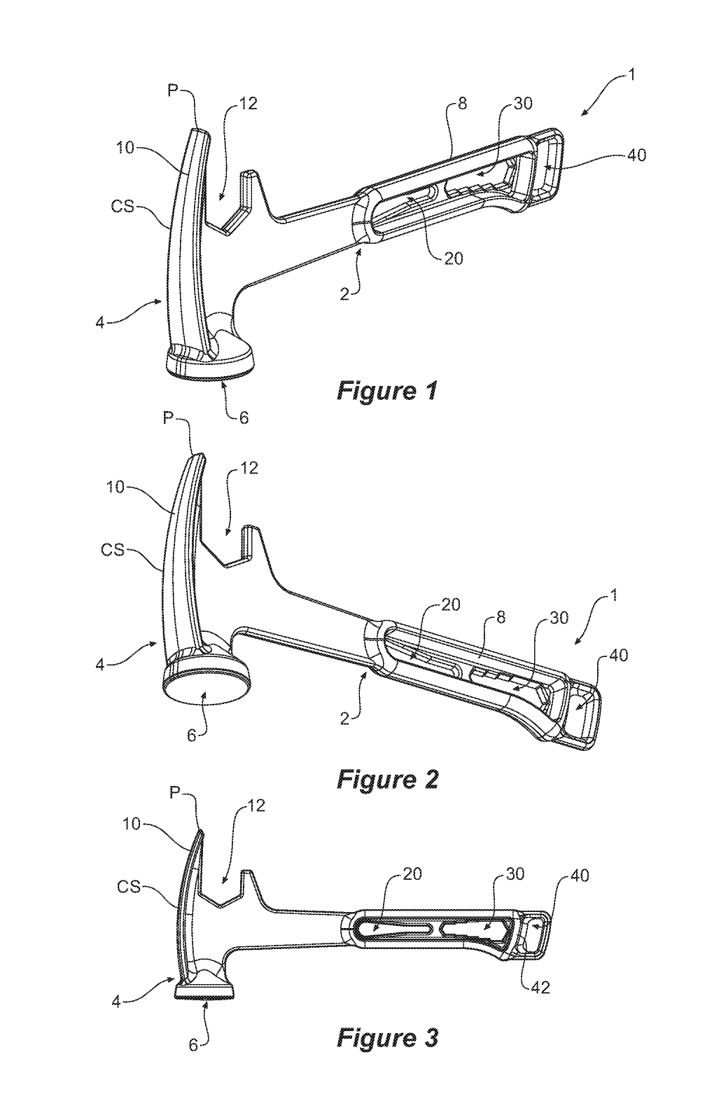

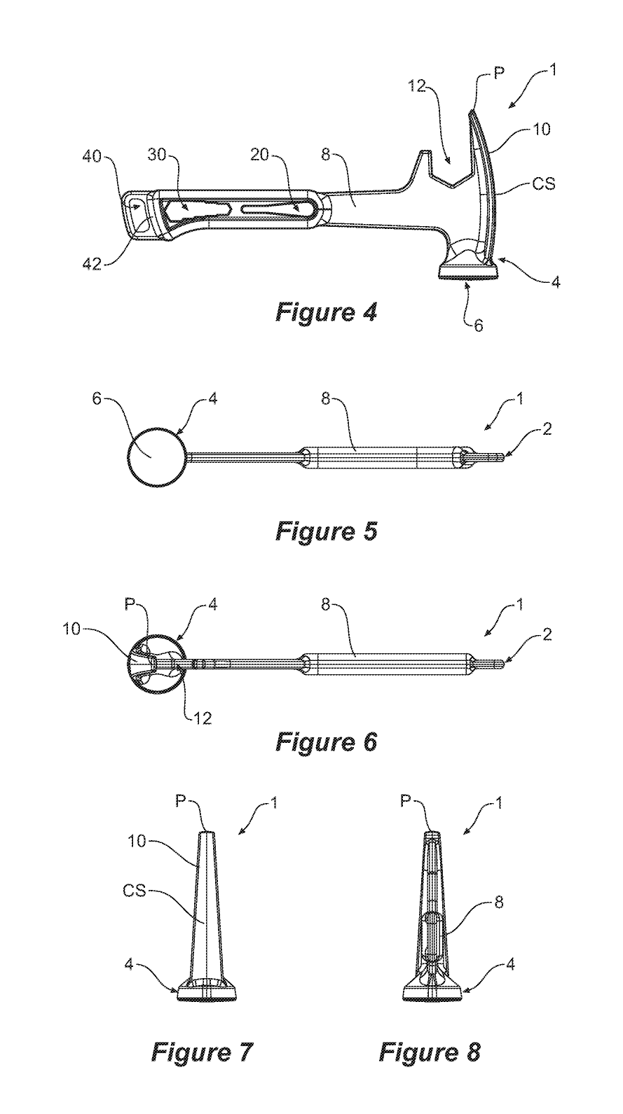

The following description provides several embodiments that relate to a multifunctional tool (hereinafter “multi tool”). Referring now to FIG. 1, where there is illustrated one representative embodiment of a multi tool 1 comprising a unitary body 2 of a metal such as a steel alloy, the body 2 comprising a hammer comprising a head 4, a face 6, and an elongate handle 8 extending from the head 4. In other embodiments, any suitable combination of the unitary body 2.

In a first embodiment of use, as a hammer, the multi tool 1 can be held by the handle 8 and the face 6 used to strike blows. In this way, the hammer can be employed to knock in tent pegs, amongst other uses.

In some embodiments, the head 4 of the hammer further comprises a spike 10 which extends rearward relative to the face 6 of the hammer. In other embodiments, a top of the head 4 of the hammer comprises a curved surface CS extending rearward from the face 6 to a point P of the spike 10.

In a further embodiment of use, the spike 10 may be inserted beneath a head of an embedded tent peg, and the handle 8 used to lever the tent peg out of the ground by pivoting the multi tool 1 on the curved surface CS of the head 4. The capability of removal of tent pegs may be used when camping with tents.

In some embodiments, the spike 10 further comprises a flat side which extends back toward the face 6 into a U-shaped wrench opening 12. The U-shaped wrench opening 12 is sized to engage around the dual flat sides incorporated into the base of a vehicle tow ball.

In a further embodiment of use, the provision of the U-shaped wrench opening 12 means that the multi tool 1 can be used to both screw and unscrew a tow ball from a ball mount. The tow ball removal capability may be used when camping with a caravan or camper trailer.

In some embodiments, the handle 8 of the multi tool 1 comprises an elongate slot 20 extending lengthwise therealong. A width of this elongate slot 20 tapers down from a first end, until it reaches a point part way therealong, at which the width becomes constant until the slot 20 terminates at a second end.

In a further embodiment of use, the elongate slot 20 can be slid over the flats on a pin for a D-shackle, and the multi tool 1 used to both screw and unscrew the pin from the D-shackle. The manipulation of the pin may be used when camping with a caravan or camper trailer.

In some embodiments, the handle 8 of the multi tool 1 further comprises a stepped slot 30 extending lengthwise therealong. A first end of this slot is shaped to nest over a hexagonal nut or head of a fastener, and the width of the slot steps down in a plurality of stages, where each successive stage is sized to accommodate a slightly smaller nut. In the case of the illustrated embodiment, the first end slot is sized to accommodate a 16 mm nut, and successive stages are sized at 14 mm, 12 mm, 10 mm and 8 mm, although alternate or even imperial sizes could be provided.

In a further embodiment of use, the stepped slot can be slid over a hexagonal nut or head of a fastener until the nut or head is nested in the stage of matching size, and the multi tool 1 used to both screw and unscrew this.

In some embodiments, an end of the handle 8 comprises a bottle opener 40 comprising an aperture comprising a lip 42. In a further mode of use, the aperture and lip 42 can be used to remove a bottle cap using a lever action, in the known manner.

One means of producing the unitary body 2 of multi tool 1, replete with all of its above mentioned features, is via casting. Some minor finishing operations may be required post casting to complete the multi tool 1. Optionally, an additive manufacturing metal fabrication technology (“3D printing”) could be employed. In other embodiments, any combination of manufacturing processes are used to create the multi tool 1.

The multi tool described above replaces multiple tools, including a hammer, a crowbar, a wrench, and a bottle opener, with a single tool. This reduces the amount and weight of equipment a user needs to take camping with them. Moreover, the multi tool is relatively simple to manufacture considering the number of functions it can perform.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

The embodiments of the invention in which an exclusive property or privilege is claimed are defined as follows:

1. A multifunctional tool, comprising:
a first tool comprising a unitary body of a hammer having a head, a face, and a handle; and
a second tool associated with the unitary body, wherein the second tool is selected from the group consisting of a spike, a U-shaped wrench opening, an elongate slot for engaging a pin of a D-shackle, an aperture for engaging a nut fastener, and a bottle opener.

2. The multifunctional tool of claim 1, further comprising a third tool associated with the unitary body, wherein the third tool is different than the second tool and selected from the group consisting of a spike, a U-shaped wrench opening, an elongate slot for engaging a pin of a D-shackle, an aperture for engaging a nut fastener, and a bottle opener.

3. The multifunctional tool of claim 2, further comprising a fourth tool associated with the unitary body, wherein the fourth tool is different than the second and third tools, the fourth tool selected from the group consisting of a spike, a U-shaped wrench opening, an elongate slot for engaging a pin of a D-shackle, an aperture for engaging a nut fastener, and a bottle opener.

4. The multifunctional tool of claim 3, further comprising a fifth tool associated with the unitary body, wherein the fifth tool is different than the second, third, and fourth tools, the fifth tool selected from the group consisting of a spike, a U-shaped wrench opening, an elongate slot for engaging a pin of a D-shackle, an aperture for engaging a nut fastener, and a bottle opener.

5. The multifunctional tool of claim 4, further comprising a sixth tool associated with the unitary body, wherein the sixth tool is different than the second, third, fourth, and fifth tools, the sixth tool selected from the group consisting of a spike, a U-shaped wrench opening, an elongate slot for engaging a pin of a D-shackle, an aperture for engaging a nut fastener, and a bottle opener.

6. The multifunctional tool of claim 1, wherein the head comprises the spike and the U-shaped wrench opening, the spike extending rearward away to the face of the hammer, and the U-shaped wrench opening positioned rearward relative to the face of the hammer.

7. The multifunctional tool of claim 1, wherein at least one of the bottle opener and the elongate slot is positioned in the handle.

8. The multifunctional tool of claim 1, wherein the body comprises a plurality of apertures for engaging nut fasteners, where each aperture is sized to engage a different sized nut fastener.

9. The multifunctional tool of claim 8, wherein the plurality of apertures for engaging nut fasteners is spaced apart along the handle.

10. The multifunctional tool of claim 1, wherein the aperture for engaging a nut fastener comprises a stepped slot for engaging various nut fastener sizes.

11. The multifunctional tool of claim 10, wherein the stepped slot is positioned in the handle.

12. The multifunctional tool of claim 1, wherein the head comprises a curved surface extending rearward from the face to a point of the spike.

13. The multifunctional tool of claim 7, wherein the elongate slot extends along the handle.

14. The multifunctional tool of claim 10, wherein the stepped slot extends along the handle.

15. The multifunctional tool of claim 7, wherein the bottle opener is positioned at the end of the handle.

16. The multifunctional tool of claim 1, wherein the unitary body is made from a metal.

17. The multifunctional tool of claim 1, wherein the unitary body is partially formed by at least one of a casting process, a machining process, an additive manufacturing process, or any combination thereof.

18. A hammer, comprising:
a unitary body having a head comprising a face, and a handle, and further comprising two of more of:
a spike;
a U-shaped wrench opening;
an elongate slot for engaging a pin of a D-shackle;
at least one aperture for engaging a nut fastener; and
a bottle opener.

19. The hammer of claim 18, wherein the body comprises each of the spike, the U-shaped wrench opening, the elongate slot for engaging a pin of a D-shackle, the aperture for engaging a nut fastener, and the bottle opener.

20. A multifunctional tool, comprising:
a unitary body of a hammer having a head, a face, and a handle;
a spike associated with the unitary body, the spike positioned on the head;
a U-shaped wrench opening associated with the unitary body, U-shaped wrench opening positioned adjacent the head;
an elongate slot associated with the unitary body for engaging a pin of a D-shackle, the elongate slot positioned on the handle;
an aperture associated with the unitary body for engaging a nut fastener, the aperture positioned on the handle; and
a bottle opener associated with the unitary body, the bottle opener positioned on the handle.
